(19) United States
(12) Patent Application Publication
(10) Pub. No.: US 2015/0019455 A1
(43) Pub. Date: Jan. 15, 2015

(54) SYSTEMS, METHODS, AND COMPUTER PROGRAM PRODUCTS FOR PROVIDING AN ADDRESS REPUTATION SERVICE

(71) Applicant: United Parcel Service of America, Inc., Atlanta, GA (US)

(72) Inventor: Mark Hilbush, Roseland, NJ (US)

(21) Appl. No.: 13/938,892

(22) Filed: Jul. 10, 2013

(51) Int. Cl. G06Q 10/08

(52) U.S. Cl. CPC G06Q 10/083
USPC 705/337

(57) ABSTRACT

Various embodiments provide an address reputation system for dynamically handling shipments for a plurality of addresses based at least in part upon a reputation score calculated therefor. The system comprises one or more computer processors configured to: receive new address data associated with at least one shipment order; retrieve at least a portion of existing address data associated with an address to which delivery is requested; dynamically compare one or more portions of the new address data against the retrieved existing address data so as to identify one or more discrepancies indicative of a conflict with a reputation score for the address; in response to identifying one or more discrepancies, prevent further processing of the shipment order; and in response to not identifying one or more discrepancies, facilitate further processing of the shipment order. Associated computer program products and computer implemented methods are also provided.

### BACKGROUND

A common challenged faced by transit companies (e.g., “carriers”) is to accurately and efficiently determine the risk of a variety of shipment transactions, as typically entered into with various third party entities (e.g., “customers”). Factors influencing risk are not only diverse, but must be generally retrieved from a variety of separately maintained systems for assessment thereof. Still further, quantitatively identifying a specific degree of risk for a particular shipment transaction relative to other shipment transactions remains difficult. Needs therefore exists for systems and methods that allow carriers to proactively calculate and assign a parameter indicative of a relative risk determination to individual locations (e.g., “addresses”) within a transit network so as to facilitate more cost-efficient transit management practices.

### BRIEF SUMMARY

According to various embodiments of the present invention, an address reputation system is provided for dynamically handling shipments for each of a plurality of addresses based at least in part upon a reputation score calculated therefor. The system comprises: one or more memory storage areas containing existing address data associated with at least one of the plurality of addresses; and one or more computer processors. The one or more computer processors are configured to: (A) receive new address data comprising order data associated with at least one shipment order for which delivery is requested to at least one of the plurality of addresses; (B) retrieve at least a portion of the existing address data, the portion being associated with the address to which delivery is requested within the new address data; (C) dynamically compare one or more portions of the new address data against one or more portions of the retrieved existing address data so as to identify one or more discrepancies there-between, the one or more discrepancies being indicative of at least one parameter within the new address data conflicting with a reputation score for the address to which delivery is requested; (D) in response to identifying one or more discrepancies, prevent further processing of the at least one shipment order within the new address data; and (E) in response to not identifying one or more discrepancies, facilitate further processing of the at least one shipment order within the new address data.

According to various embodiments of the present invention, a computer-implemented method is provided for dynamically handling shipments for each of a plurality of addresses based at least in part upon a reputation score calculated therefor. Various embodiments of the method comprise the steps of: (A) receiving and storing within one or more memory storage areas existing address data associated with at least one of the plurality of addresses; (B) receiving new address data comprising order data associated with at least one shipment order for which delivery is requested to at least one of the plurality of addresses; (C) dynamically comparing, via at least one computer processor, one or more portions of the new address data against one or more portions of the retrieved existing address data so as to identify one or more discrepancies there-between, the one or more discrepancies being indicative of at least one parameter within the new address data conflicting with a reputation score for the address to which delivery is requested; (D) in response to identifying one or more discrepancies, preventing, via the at least one computer processor, further processing of the at least one shipment order within the new address data; and (E) in response to not identifying one or more discrepancies, facilitating, via the at least one computer processors, further processing of the at least one shipment order within the new address data.

According to various embodiments of the present invention, a non-transitory computer program product is provided comprising at least one computer-readable storage medium having computer-readable program code portions embodied therein. The computer-readable program code portions comprise: (A) a first executable portion configured for receiving a plurality of data, wherein the data comprises: (i) existing address data associated with at least one of a plurality of addresses; and (ii) new address data comprising order data associated with at least one shipment order for which delivery is requested to at least one of the plurality of addresses. The computer-readable program code portions further comprise: (B) a second executable portion configured for dynamically comparing one or more portions of the new address data against one or more portions of the retrieved existing address data so as to identify one or more discrepancies there-between, the one or more discrepancies being indicative of at least one parameter within the new address data conflicting with a reputation score for the address to which delivery is requested; and (C) a third executable portion configured for: (i) in response to identifying one or more discrepancies, prevent further processing of the at least one shipment order within the new address data; and (ii) in response to not identifying one or more discrepancies, facilitate further processing of the at least one shipment order within the new address data.

### BRIEF DESCRIPTION OF THE SEVERAL VIEWS OF THE DRAWING(S)

The accompanying drawings incorporated herein and forming a part of the disclosure illustrate several aspects of the present invention and together with the detailed description serve to explain certain principles of the present invention. In the drawings, which are not necessarily drawn to scale:

FIG. 1 is a block diagram of an address (e.g., address) reputation system 20 according to various embodiments;

FIG. 2 is schematic block diagram of an address reputation server 200 according to various embodiments;

FIG. 3 illustrates an overall process flow for various modules of the address reputation server 200 according to various embodiments;

FIG. 4 illustrates a schematic diagram of various databases that are utilized by the address reputation system 20 shown in FIG. 1 according to various embodiments;

FIG. 5 is a schematic block diagram of a data module 400, a calculation module 500, an analysis module 600, and a report module 700, all as also illustrated in FIGS. 2 and 3 according to various embodiments;

FIG. 6 illustrates an exemplary process flow according to various embodiments for the data module 400 shown in FIGS. 2 and 5;

FIG. 7 illustrates an exemplary process flow according to various embodiments for the calculation module 500 shown in FIGS. 2 and 5;

FIG. 8 illustrates an exemplary process flow according to various embodiments for the analysis module 600 shown in FIGS. 2 and 5; and

FIG. 9 illustrates an exemplary process flow according to various embodiments for the report module 700 shown in FIGS. 2 and 5.

### DETAILED DESCRIPTION OF VARIOUS EMBODIMENTS

Various embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein. Rather, these embodiments are provided so that this disclosure will satisfy applicable legal requirements. Unless otherwise defined, all technical and scientific terms used herein have the same meaning as commonly known and understood by one of ordinary skill in the art to which the invention relates. The term “or” is used herein in both the alternative and conjunctive sense, unless otherwise indicated. Like numbers refer to like elements throughout.

Apparatuses, Methods, Systems, and Computer Program Products

Embodiments of the present invention may be implemented in various ways, including as computer program products. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory, multimedia memory cards (MMC), secure digital (SD) memory cards, Memory Sticks, and/or the like. Further, a nonvolatile computer-readable storage medium may also include conductive-bridging random access memory (CBRAM), phase-change random access memory (PRAM), ferroelectric random-access memory (FeRAM), resistive random-access memory (RRAM), Silicon-Oxide-Nitride-Oxide-Silicon memory (SONOS), racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended information/data-out dynamic random access memory (EDO DRAM), synchronous dynamic random access memory (SDRAM), double information/data rate synchronous dynamic random access memory (DDR SDRAM), double information/data rate type two synchronous dynamic random access memory (DDR2 SDRAM), double information/data rate type three synchronous dynamic random access memory (DDR3 SDRAM), Rambus dynamic random access memory (RDRAM), Rambus in-line memory module (RIMM), dual in-line memory module (DIMM), single in-line memory module (SIMM), video random access memory VRAM, cache memory, register memory, and/or the like. It will be appreciated that where embodiments are described to use computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. However, embodiments of the present invention may also take the form of an entirely hardware embodiment performing certain steps or operations.

Various embodiments are described below with reference to block diagrams and flowchart illustrations of apparatuses, methods, systems, and computer program products. It should be understood that each block of any of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, could be implemented by special purpose hardware-based computer systems that perform the specified functions or operations, or combinations of special purpose hardware and computer instructions.

Exemplary System Architecture

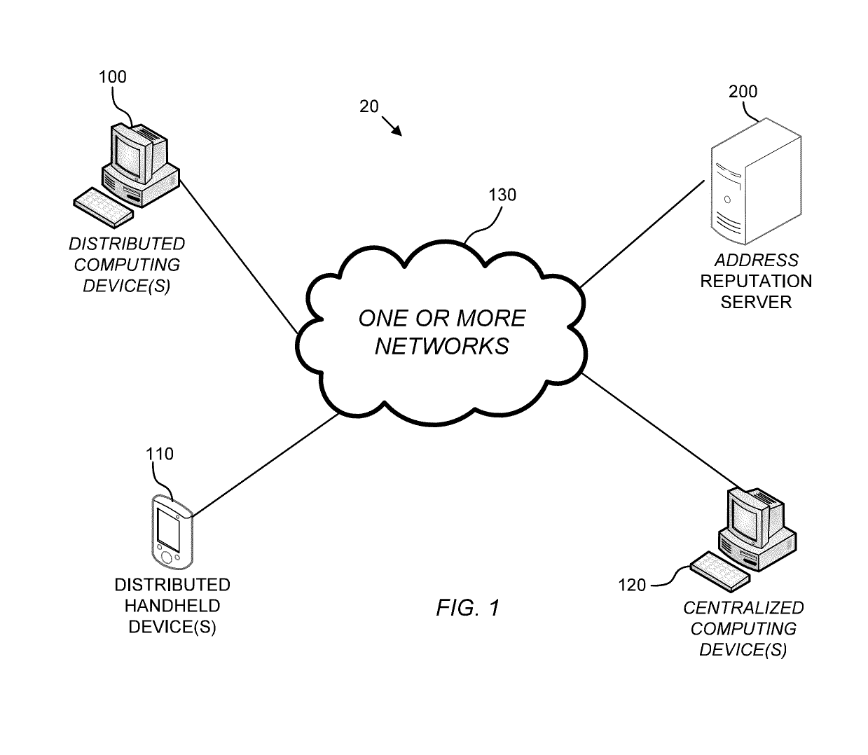

FIG. 1 is a block diagram of an address reputation system 20 that can be used in conjunction with various embodiments of the present invention. In at least the illustrated embodiment, the address reputation system 20 may include one or more distributed computing devices 100, one or more distributed handheld devices 110, and one or more central computing devices 120, each configured in communication with an address reputation server 200 via one or more networks 130. While FIG. 1 illustrates the various system entities as separate, standalone entities, the various embodiments are not limited to this particular architecture.

According to various embodiments of the present invention, the one or more networks 130 may be capable of supporting communication in accordance with any one or more of a number of second-generation (2G), 2.5G, third-generation (3G), and/or fourth-generation (4G) mobile communication protocols, or the like. More particularly, the one or more networks 130 may be capable of supporting communication in accordance with 2G wireless communication protocols IS-136 (TDMA), GSM, and IS-95 (CDMA). Also, for example, the one or more networks 130 may be capable of supporting communication in accordance with 2.5G wireless communication protocols GPRS, Enhanced Data GSM Environment (EDGE), or the like. In addition, for example, the one or more networks 130 may be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones). As yet another example, each of the components of the system 5 may be configured to communicate with one another in accordance with techniques such as, for example, radio frequency (RF), Bluetooth™, infrared (IrDA), or any of a number of different wired or wireless networking techniques, including a wired or wireless Personal Area Network (“PAN”), Local Area Network (“LAN”), Metropolitan Area Network (“MAN”), Wide Area Network (“WAN”), or the like.

Although the distributed computing device(s) 100, the distributed handheld device(s) 110, the central computing device(s) 120, and the address reputation server 200 are illustrated in FIG. 1 as communicating with one another over the same network 130, these devices may likewise communicate over multiple, separate networks. For example, while the central computing devices 120 may communicate with the server 200 over a wireless personal area network (WPAN) using, for example, Bluetooth techniques, one or more of the distributed devices 100, 110 may communicate with the server 200 over a wireless wide area network (WWAN), for example, in accordance with EDGE, or some other 2.5G wireless communication protocol.

According to one embodiment, in addition to receiving data from the address reputation server 200, the distributed computing devices 100, the distributed handheld devices 110, and the central computing devices 120 may be further configured to collect and transmit data on their own. Indeed, the distributed computing devices 100, the distributed handheld devices 110, and the central computing devices 120 may be any device associated with a carrier (e.g., a common carrier, such as UPS, FedEx, USPS, etc.). In certain embodiments, one or more of the distributed computing devices 100 and the distributed handheld devices 110 may be associated with an independent third party user, as opposed to a carrier. Regardless, in various embodiments, the distributed computing devices 100, the distributed handheld devices 110, and the central computing devices 120 may be capable of receiving data via one or more input units or devices, such as a keypad, touchpad, barcode scanner, radio frequency identification (RFID) reader, interface card (e.g., modem, etc.) or receiver. The distributed computing devices 100, the distributed handheld devices 110, and the central computing devices 120 may further be capable of storing data to one or more volatile or non-volatile memory modules, and outputting the data via one or more output units or devices, for example, by displaying data to the user operating the device, or by transmitting data, for example over the one or more networks 130. One type of a distributed handheld device 110, which may be used in conjunction with embodiments of the present invention is the Delivery Information Acquisition Device (DIAD) presently utilized by UPS.

Address Reputation Server 200

In various embodiments, the address reputation server 200 includes various systems for performing one or more functions in accordance with various embodiments of the present invention, including those more particularly shown and described herein. It should be understood, however, that the address reputation server 200 might include a variety of alternative devices for performing one or more like functions, without departing from the spirit and scope of the present invention. For example, at least a portion of the server 200, in certain embodiments, may be located on the distributed computing device(s) 100, the distributed handheld device(s) 110, and the central computing device(s) 120, as may be desirable for particular applications.

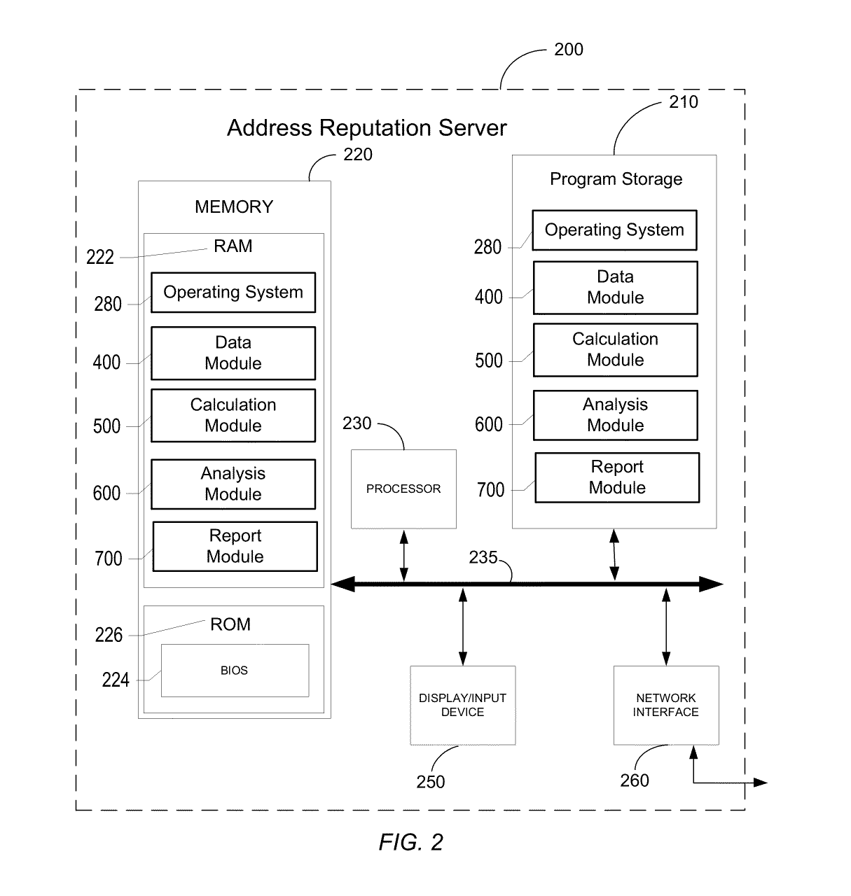

FIG. 2 is a schematic diagram of the address reputation server 200 according to various embodiments. The server 200 includes a processor 230 that communicates with other elements within the server via a system interface or bus 235. Also included in the server 200 is a display/input device 250 for receiving and displaying data. This display/input device 250 may be, for example, a keyboard or pointing device that is used in combination with a monitor. The server 200 further includes memory 220, which preferably includes both read only memory (ROM) 226 and random access memory (RAM) 222. The server's ROM 226 is used to store a basic input/output system 224 (BIOS), containing the basic routines that help to transfer information between elements within the server 200. Various ROM and RAM configurations have been previously described herein.

In addition, the address reputation server 200 includes at least one storage device or program storage 210, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 210 are connected to the system bus 235 by an appropriate interface. The storage devices 210 and their associated computer-readable media provide nonvolatile storage for a personal computer. As will be appreciated by one of ordinary skill in the art, the computer-readable media described above could be replaced by any other type of computer-readable media known in the art. Such media include, for example, magnetic cassettes, flash memory cards, digital video disks, and Bernoulli cartridges.

Although not shown, according to an embodiment, the storage device 210 and/or memory of the address reputation server 200 may further provide the functions of a data storage device, which may store historical and/or current delivery data and delivery conditions that may be accessed by the server 200. In this regard, the storage device 210 may comprise one or more databases. The term “database” refers to a structured collection of records or data that is stored in a computer system, such as via a relational database, hierarchical database, or network database and as such, should not be construed in a limiting fashion.

A number of program modules comprising, for example, one or more computer-readable program code portions executable by the processor 230, may be stored by the various storage devices 210 and within RAM 222. Such program modules include an operating system 280, a data module 400, a calculation module 500, an analysis module 600, and a report module 700. In these and other embodiments, the various modules 400, 500, 600, 700 control certain aspects of the operation of the address reputation server 200 with the assistance of the processor 230 and operating system 280. In still other embodiments, it should be understood that one or more additional and/or alternative modules may also be provided, without departing from the scope and nature of the present invention.

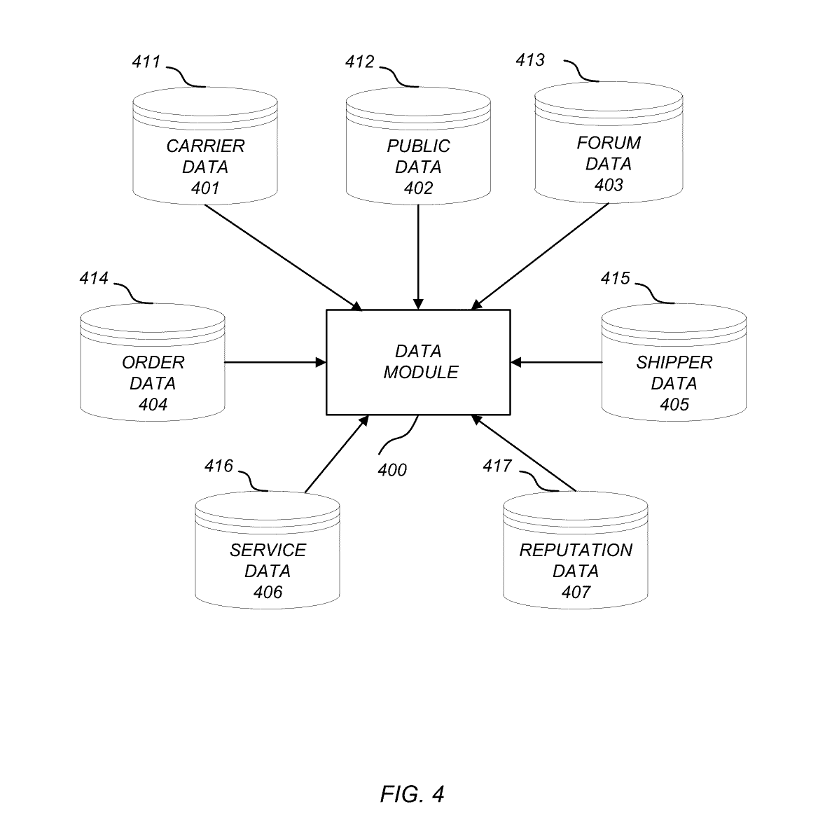

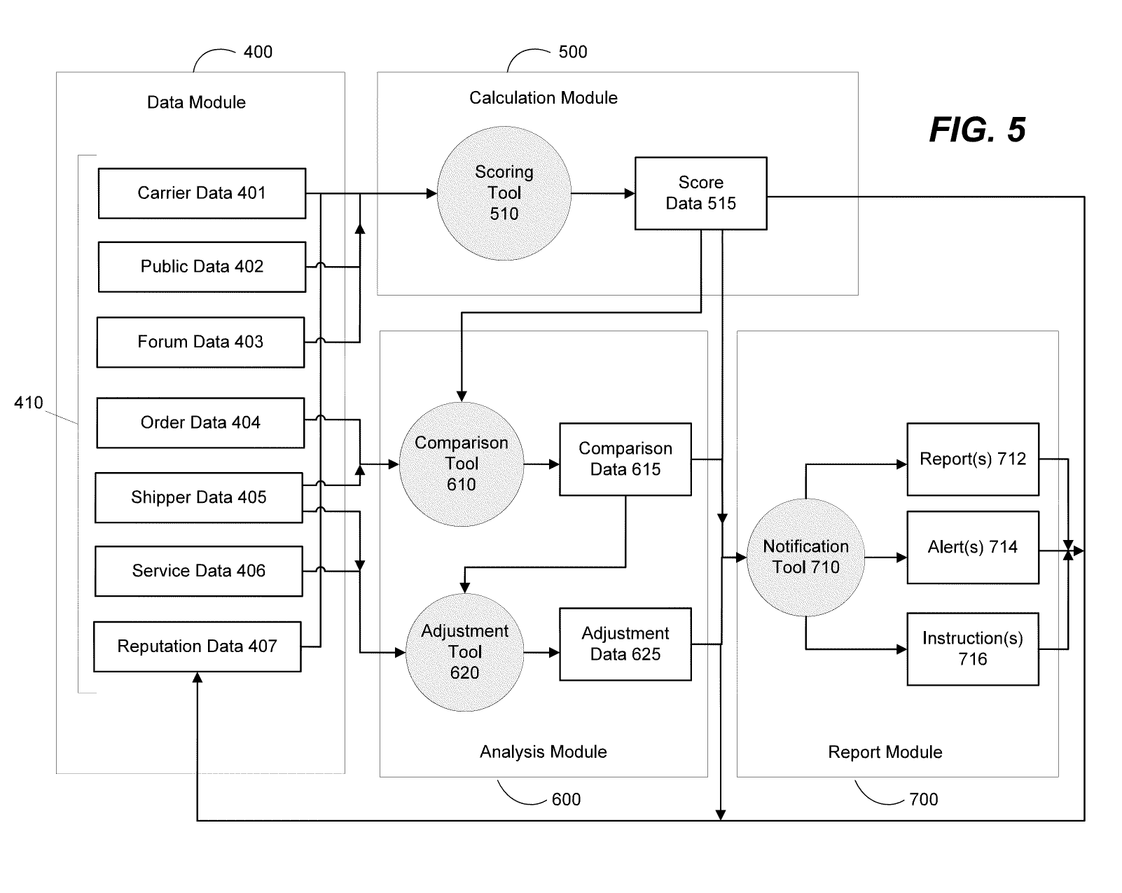

In general, as will be described in further detail below, the data module 400 is configured to receive, store, manage, and transmit address data 410, which may comprise any of a variety of data associated with each of a plurality of service (e.g., delivery) points within a carrier's shipping network (see FIG. 5). Details regarding various types of address data 410 will be described elsewhere herein with reference to at least FIG. 4. Returning to FIG. 5, according to various embodiments, the data module 400 is configured to provide at least a portion of the address data 410 to the calculation module 500, whether proactively or upon request therefor. In certain embodiments, at least a portion of the address data 410 may be separately and/or alternatively provided to the analysis module 600, as will be described in further detail below. Amongst a variety of considerations, the determination of which module (500, 600) that the various portions of the address data 410 is transmitted depends at least in part upon the context and type of data received.

Upon receipt and/or retrieval of any portion of the address data 410 the calculation module 500 is configured to activate a scoring tool 510 (see FIG. 5). The scoring tool 510 is configured to calculate a reputation score for the one or more addresses associated with the received address data 410. The reputation score may be accompanied by a variety of score data 515 in certain embodiments, as may be desirable for particular applications. Upon generation of the score data 515, such is transmitted according to various embodiments to one or more of the analysis module 600 and/or the data module 400 for further processing. Such transmittal may be proactive or in response to a request or inquiry originating from one of the modules.

According to various embodiments, the analysis module 600 is configured to activate a comparison tool 610 upon receipt of at least certain portions of the address data 410. The comparison tool 610 is configured in certain embodiments to assess discrepancies and/or conflicts between subsets of the received portions of data 410. Any identified discrepancies and/or conflicts are compiled as comparison data 615, which the analysis module 600 is configured, according to various embodiments, to provide as input to an adjustment tool 620. If no discrepancies and/or conflicts are identified, the comparison data 615, as may be generated, may be provided alternatively to the report module 700. The adjustment tool 620 in certain embodiments is configured to mitigate and/or otherwise address any areas of concern identified within the comparison data 615, thus generating adjustment data 625 that may, to some degree, modify the initially received address data 410. According to various embodiments, the comparison data 615 and/or the adjustment data 625 may be transmitted by the analysis module 600 to the report module 700.

According to various embodiments, the report module 700 is configured to activate a notification tool 710 to further process received score data 515, comparison data 615, and/or adjustment data 625. In certain embodiments, the report module 700 generates one or more reports 712, alerts 714, and/or instructions 716 to one or more users of the system (e.g., carrier, customer, etc.), however as may be desirable. All of these features and still further details surrounding the operation and configuration of the various modules 400, 500, and 600 will be described in further detail later herein.

In various embodiments, the program modules 400, 500, 600, 700 are executed by the address reputation server 200 and are configured to generate one or more graphical user interfaces, reports, instructions, and/or notifications/alerts, all accessible and/or transmittable to various users of the system 20. In certain embodiments, the user interfaces, reports, instructions, and/or notifications/alerts may be accessible via one or more networks 130, which may include the Internet or other feasible communications network, as previously discussed. In other embodiments, one or more of the modules 400, 500, 600, 700 may be alternatively and/or additionally (e.g., in duplicate) stored locally on one or more of the distributed computing devices 100, the distributed handheld devices 110, and/or the central computing devices 120, and may be executed by one or more processors of the same. According to various embodiments, the modules 400, 500, 600, 700 may send data to, receive data from, and utilize data contained in, one or more databases, which may be comprised of one or more separate, linked and/or networked databases.

Also located within the address reputation server 200 is a network interface 260 for interfacing and communicating with other elements of the one or more networks 130. It will be appreciated by one of ordinary skill in the art that one or more of the server 200 components may be located geographically remotely from other server components. Furthermore, one or more of the server 200 components may be combined, and/or additional components performing functions described herein may also be included in the server.

While the foregoing describes a single processor 230, as one of ordinary skill in the art will recognize, the address reputation server 200 may comprise multiple processors operating in conjunction with one another to perform the functionality described herein. In addition to the memory 220, the processor 230 can also be connected to at least one interface or other means for displaying, transmitting and/or receiving data, content or the like. In this regard, the interface(s) can include at least one communication interface or other means for transmitting and/or receiving data, content or the like, as well as at least one user interface that can include a display and/or a user input interface, as will be described in further detail below. The user input interface, in turn, can comprise any of a number of devices allowing the entity to receive data from a user, such as a keypad, a touch display, a joystick or other input device.

While reference is made to the “server” 200, as one of ordinary skill in the art will recognize, embodiments of the present invention are not limited to traditionally defined server architectures. Still further, the system of embodiments of the present invention is not limited to a single server, or similar network entity or mainframe computer system. Other similar architectures including one or more network entities operating in conjunction with one another to provide the functionality described herein may likewise be used without departing from the spirit and scope of embodiments of the present invention. For example, a mesh network of two or more personal computers (PCs), similar electronic devices, or handheld portable devices, collaborating with one another to provide the functionality described herein in association with the server 200 may likewise be used without departing from the spirit and scope of embodiments of the present invention.

According to various embodiments, many individual steps of a process may or may not be carried out utilizing the computer systems and/or servers described herein, and the degree of computer implementation may vary.

Address Reputation Server 200 Logic Flow

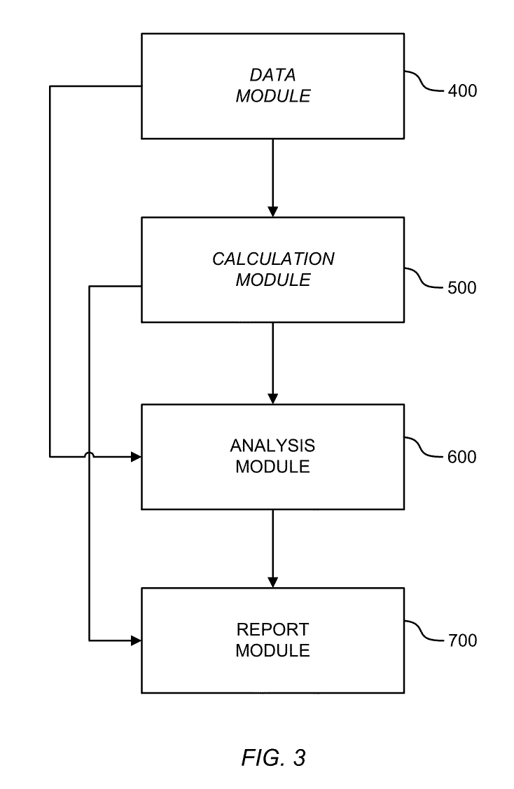

Reference is now made to FIGS. 3-9, which illustrate various logical process flows executed by various embodiments of the modules described above. In particular, FIG. 3 illustrates the overall relationship of the modules 400, 500, 600, 700 of the address reputation server 200, according to various embodiments. As illustrated, operation of the system 20 begins, according to various embodiments, with the execution of the data module 400, which is configured to receive, store, manage, and transmit any of a variety of types of address data 410 (see FIG. 5). Certain portions of the data are provided, as desirable, to at least the calculation module 500 and the analysis module 600. As a non-limiting example, when carrier data 401 indicative of some issue encountered with delivery to a particular address is received by the data module 400, such may be transmitted to the calculation module 500 for updating a reputation score and any related score data 515 associated with the particular address. As another non-limiting example, when order data 404 requesting a new shipment from a particular address with certain parameters is received by the data module 400, such may be transmitted to the analysis module 600 to ascertain whether any portion of the request conflicts with pre-existing data associated with the particular address. Still other non-limiting examples will be described in further detail elsewhere herein.

The calculation module 500 is configured according to various embodiments to, upon receipt of any address data 410 to activate a scoring tool 510 (see FIG. 5). The scoring tool 510 is configured to calculate a reputation score for the one or more addresses associated with the received address data 410. As previously mentioned, the reputation score may be accompanied by a variety of score data 515 in certain embodiments, as may be desirable for particular applications. Upon generation of the score data 515, such is transmitted according to various embodiments to one or more of the analysis module 600, the report module 700, and/or the data module 400 for further processing.

If instead of ongoing shipment data or data associated therewith, the newly received data comprises a new request for shipment (e.g., an order), the analysis module 600 is configured according to various embodiments to receipt such and via a comparison tool 610, assess the same against other portions of the address data 410. For example, one or more parameters within the order data 404 (see FIG. 5) may be compared any one or more corresponding parameters within pre-existing shipper data 405, so as to ensure that the request falls within the parameters, however as may have been established by a shipper or carrier of goods or packages to a particular address.

The comparison tool 610 of the analysis module 600 is further configured according to various embodiments to generate comparison data 615. If no discrepancies or issues are identified, such data 615 may be transmitted to the report module 700 for handling as described elsewhere herein; otherwise such is transmitted in certain embodiments to an adjustment tool 620 of the analysis module. According to various embodiments, the adjustment tool 620 is configured to mitigate any identified discrepancies and/or issues, so as to facilitate shipment of the package regardless thereof. Such mitigation may involve retrieving and/or analyzing at least a service data 406 portion of the address data 410. In any event, the adjustment tool 620 is configured to generate adjustment data 625, which may be likewise transmitted to at least the report module 700 (see FIG. 5).

According to various embodiments, the report module 700 is configured to activate a notification tool 710 to further process received score data 515, comparison data 615, and/or adjustment data 625. In certain embodiments, the report module 700 generates one or more reports 712, alerts 714, and/or instructions 716 to one or more users of the system (e.g., carrier, customer, etc.), however as may be desirable. All of these features and still further details surrounding the operation and configuration of the various modules 400, 500, and 600 will be described in further detail later herein.

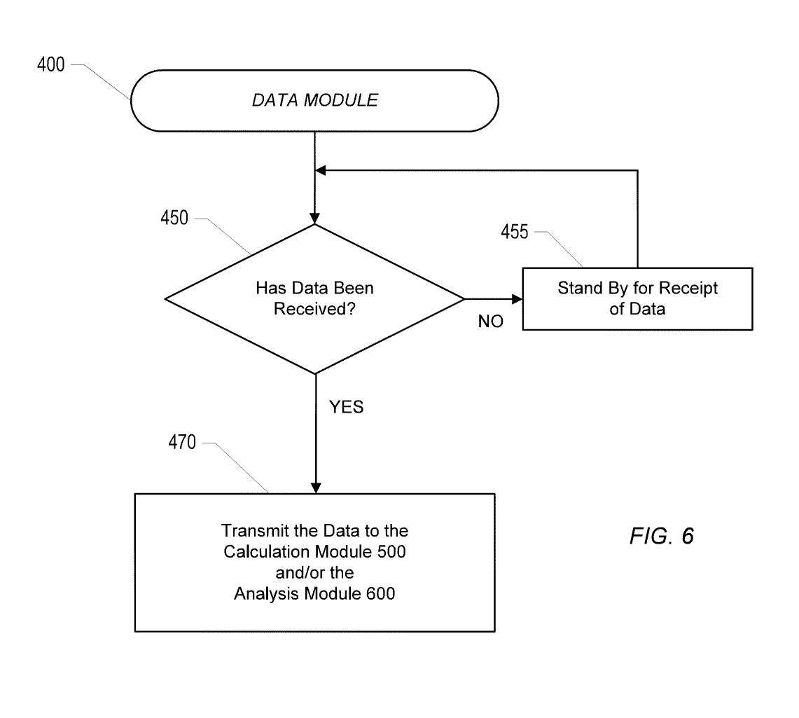

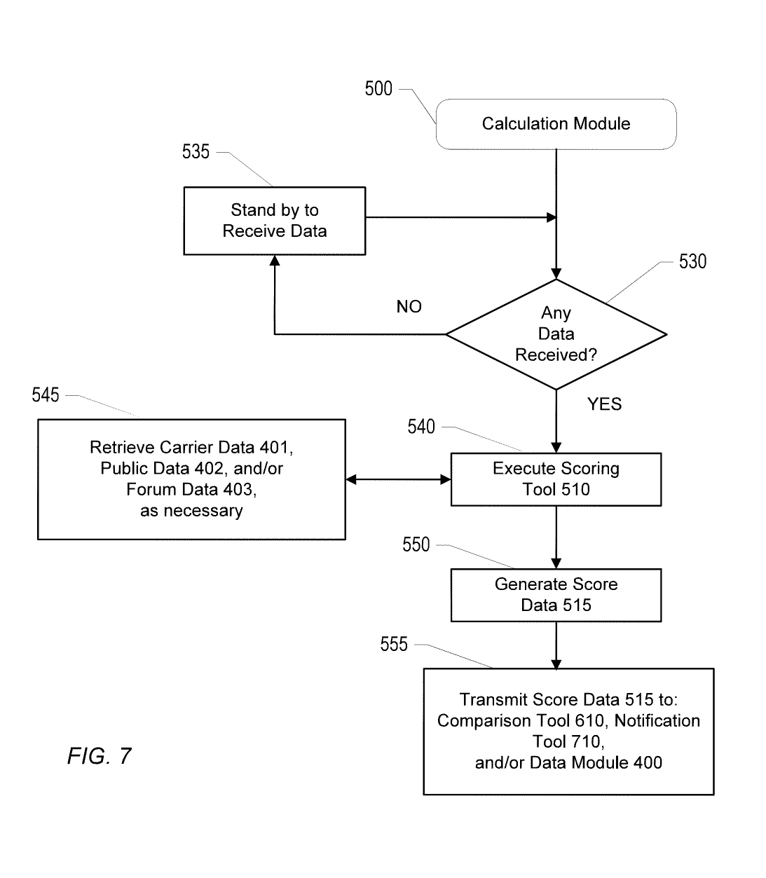

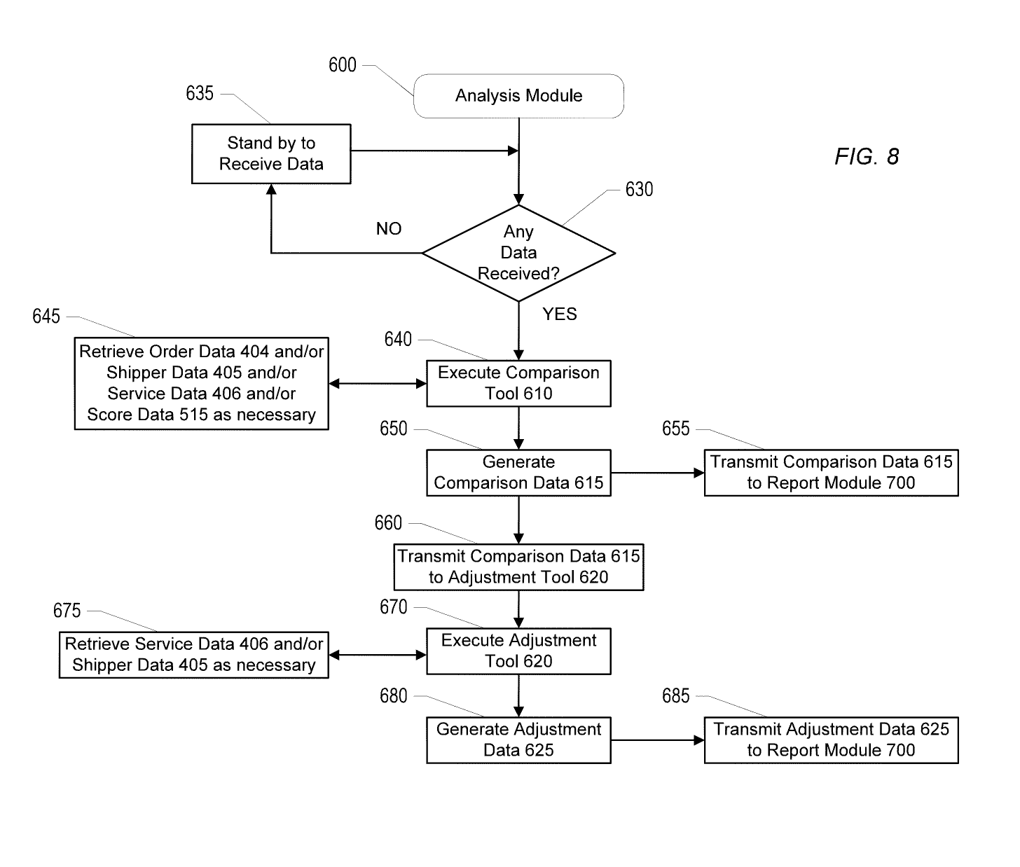

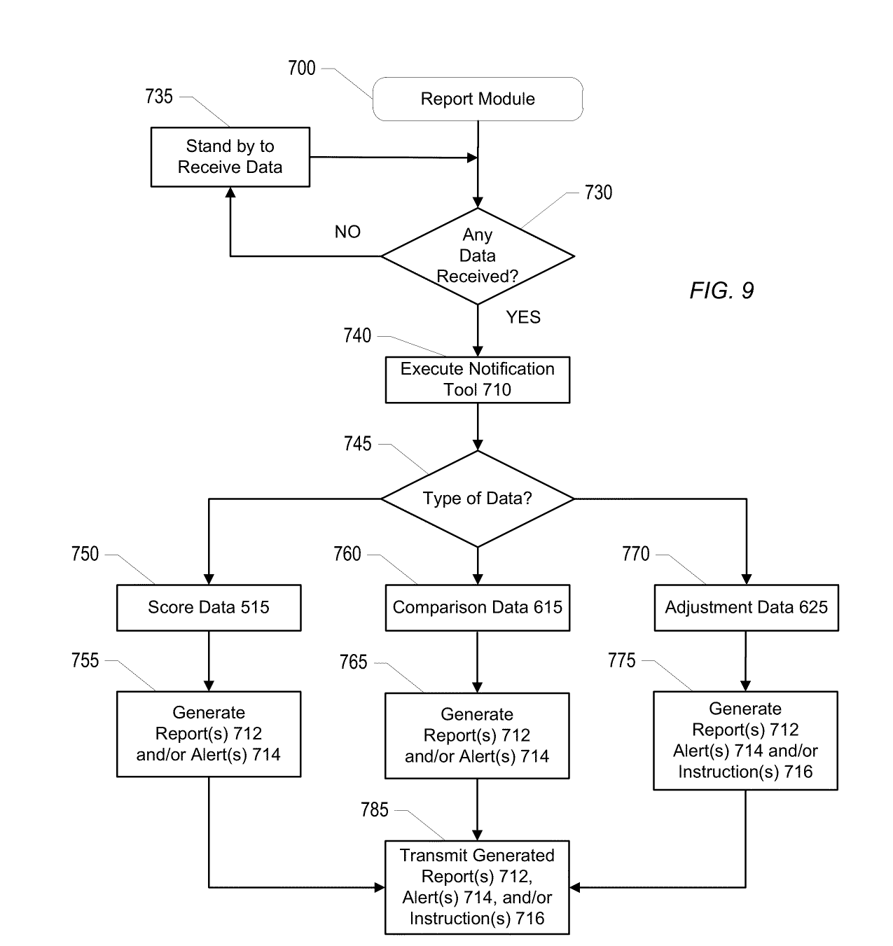

Detailed steps performed by various embodiments of the data module 400 are described in relation to FIG. 6; detailed steps performed by various embodiments of the calculation module 500 are described in relation to FIG. 7; detailed steps performed by various embodiments of the analysis module 600 are described in relation to FIG. 8; and detailed steps performed by various embodiments of the report module 600 are described in relation to FIG. 9.

As will be described in more detail below in relation to FIGS. 4 and 5, the data module 400, according to various embodiments, is configured to receive, store, manage, and transmit any of a variety of types of address data 410 between one or more databases in communication with the module 400 and at least the calculation module 500 and/or the analysis module 600. FIG. 4 illustrates a block diagram of various exemplary databases via which the data module 400 manages this information. In particular, in at least the embodiment shown in FIG. 4, the following databases are provided: a carrier data database 411, a public data database 412, a forum data database 413, an order data database 414, a shipper data database 415, a service data database 416, and a reputation data database 417. Although the embodiment of FIG. 4 shows these databases 411-417 as being separate databases each associated with different types of data, in various other embodiments, some or all of the data may be stored in the same database. In still other embodiments, additional and/or alternative databases may be provided, as may also be desirable for particular applications.

Generally speaking, it should be understood with reference to FIG. 4 that the various categories of data 401-407 stored within the separate (as illustrated) databases 411-417 may be according to various embodiments associated with a plurality of addresses (e.g., locations where a service is provided, whether delivery, pickup, or otherwise, as may be sometimes alternatively referred to as a “service point”) within a service network operated by a common carrier (e.g., UPS, FedEx, DHL, etc.). In certain embodiments, the common carrier may be a primary operator of the system 20 described herein, although in other embodiments, any of a variety of entities and/or parties may undertake such responsibility. It should be understood of course, however, that due to the extensive degree of carrier data 401 that provides input, at least in part, for operation of the system 20, a common carrier of some sort should typically be fairly involved with the system. Indeed, beyond other pieces and types of carrier data 401, as will be described further below, a common carrier may be able to provide data identifying each of a plurality of discrete addresses within a service or delivery network, which points will be associated according to various embodiments with substantially all of the various types of data 401-407 described further below.

According to various embodiments, the carrier data database 411 may be configured to store and maintain a variety of carrier-related data 401. In certain embodiments, the carrier data 401 may comprise any of a variety of information related to the transportation of one or more shipments (e.g., packages) to one or more addresses within the service network of the system 20 (e.g., that of the carrier). For example, a shipment's immediate location and/or status information during handling by a carrier may be contained within the carrier data 401. As the shipment is transported from one routing facility to another, loaded and unloaded onto vehicles or aircraft, a shipment identification number, as such are commonly known and understood in the art, can be used to as an index for providing tracking information. The tracking information may be thus input into the data module 400 of the system 20, identified as carrier data 401 and be stored within the carrier data database 411 accordingly. Other non-limiting examples of carrier data 401 include delivery statistics (e.g., volume, frequency, diversity, industry, etc.), tracking data (e.g., scans, mis-scans, misreads, late pickups, reroutes, late arrivals, late departures, late deliveries, and the like), shipping statistics (e.g., volume frequency, etc.), historical claims data, historical fraud data (e.g., blocked user/customer IDs due to fraud or other factors), undeliverable address data, and the like.

It should be understood that according to various embodiments, a variety of details regarding these and still other types of carrier data 401 may be stored within the database 411. Indeed, in certain embodiments, the carrier data 401 may include further identifying data associated with a plurality of addresses, which inherently form a sort of internal framework for analyzing the various types of data 401-407 within the system 20. Such address data, as may be inherent within the carrier data 401, may include such information as address, geographic location, zip code, resident name, resident contact information, and the like. In certain embodiments, the carrier data 401 may include certain data collected by a common carrier entity during transit of a package or item, whereby if the data includes, for example, a rerouting to a new address, the system 20 may be configured to reassess the same, as will be described in the context of the calculation and analysis modules 500-600. In any event, regardless of the particular content of the carrier data 401, in these and still other embodiments, it should be understood that, upon receipt, the carrier data database 411 will store any newly received carrier data in a manner associated with at least the data module 400 and for provision (whether automatically, manually, or at a later time) to at least the calculation module 500, as will be described in further detail below.

According to various embodiments, the public data database 412 may be configured to store and maintain any of a variety of public data 402 associated with each of the plurality of addresses within a network serviced by one or more common carriers associated with the system 20 described herein. In certain embodiments, the public data 402 may comprise demographic data, fraud complaint data, civil legal complaint data, criminal legal complaint data, any legal judgment data, and/or any criminal record data, any of which as may be associated with one or more individuals and/or entities associated with the address of the address. Still further non-limiting examples of public data 402 comprise law enforcement statistics, which may comprise area burglaries, robberies, thefts, felonies, misdemeanors, and the like, as all contribute to the general “risk” associated with delivery of shipments to such areas, particularly under circumstances where such shipments (e.g., one or more packages) may be left outside a structure for later pick-up by a recipient thereof. Generally speaking, it should be understood that, upon receipt of any such public data 412, the public data database 412 will store such in a manner associated with at least the data module 400 and for provision (whether automatically, manually, or at a later time) to at least the calculation module 500, as will also be described in further detail below. Of course, in any of these and still other embodiments, a variety of alternative configurations could exist, as commonly known and understood in the art.

According to various embodiments, the forum data database 413 may be configured to store and maintain a variety of forum data 403, which may generally include a plurality of pieces of information associated with and/or related to one or more particular addresses within the carrier data 410 and/or an individual or entity associated with the same. The pieces of information may be positive and/or negative feedback regarding prior deliveries to a particular address, as may be submitted by any of a variety of shipping providers and/or retail organizations that may have conducted a transaction that was delivered to the particular address. In certain embodiments, the forum data 403 may further provide information submitted by any of a variety of third party users of the system 20, although it should be understood that in at least one embodiment third party submitted data may be subject to verification before being officially applied against a particular address and factoring into a reputation score calculation, as will be described elsewhere herein. In other embodiments, even the individuals and/or entity may be able to submit forum data 403, for example via a chat room or listsery associated with the system 20 or otherwise integrated therewith, whether to provide updated information (e.g., as non-limiting examples “I just moved out of this house; please update.” or “I just moved into this house, so please remove historical data related to prior owners.” or “I refused that prior shipment because it was damaged; not because of any fault of mine.”). In this manner, it should be generally understood that the forum data 403 may be configured such that a plurality of users and/or accessing parties of the system 20 may contribute to such so as to improve the accuracy and completeness of data surrounding individual addresses within the system. In any of these embodiments, upon receipt, the database 413 will store any such received/updated forum data 403 in a manner associated with at least the data module 400 and for provision (whether automatically, manually, or at a later time) to at least the calculation module 500, as will also be described in further detail below. Of course, in still other embodiments, a variety of alternative configurations could exist, as commonly known and understood in the art.

According to various embodiments, the order data database 414 may be configured to receive, store, and maintain order data 404 that may comprise any of a variety of information associated with one or more shipment requests submitted by one or more users of the system 20 described herein. As a non-limiting example, the order data 404 may comprise a request by a customer to have a package shipped from retailer A to address B associated with address C, within 48 hours, via a two-day air service designation. Any of a variety of handling, transport, and delivery parameters may be included within the order data 404, any of which as may be selected by a user/customer, for example via an interface (e.g., a web portal) upon which such shipment orders may be placed, as are commonly known and used in the art. Still further non-limiting examples of order data 404 may comprise customer financial and/or personal data and the like, such that the system 20 may interactively determine which particular address the shipment request should be associated with, for example, by matching the customer data with a pre-existing association within, for example, the carrier data 401 or public data 402, as described elsewhere herein. In certain embodiments, at least a portion of the order data 402 may comprise instructions from a user of the system, received by the data module 400 following transmission of one or more alerts 714 to the user, as will be described elsewhere herein. In other embodiments, at least a portion of the order data 402 may comprise instructions initiated by a user of the system proactively and when such involves, for example, a request to alter a delivery address, at least the analysis module 600 may reassess such, as will be described elsewhere herein. Still further, in any of these and still other embodiments, upon receipt, the order data database 414 will store any such received order data 404 in a manner associated with at least the data module 400 and for provision to at least the analysis module 600 (see FIG. 5), as will also be described in further detail below. Of course, in any of these and still other embodiments, a variety of alternative configurations could exist, as commonly known and understood in the art.

According to various embodiments, the shipper data database 415 may be configured to receive, store, and maintain shipper data 405 that may comprise any of a variety of information associated with one or more shipping providers available for selection by one or more users of the system 20 described herein. Non-limiting examples of shipper data 405 include a business rule of a particular shipper that they will only ship to addresses have a reputation score above a certain minimum threshold. In other embodiments, varying service levels and/or charges therefor may be required by particular shippers, based at least in part upon the reputation score and/or score data 515 associated with a particular address. A non-limiting example would be a shipper imposing a surcharge for delivery to an address having a reputation score of 80 on a scale of 0-100, wherein any scores greater than 75 are designated as “high risk.” A variety of alternatives may be envisioned, within the scope and nature of the present invention. Still further, in any of these and still other embodiments, upon receipt, the shipper data database 415 will store any such received shipper data 405 in a manner associated with at least the data module 400 and for provision to at least the analysis module 600 (see FIG. 5), as will also be described in further detail below. Of course, in any of these and still other embodiments, a variety of alternative configurations could exist, as commonly known and understood in the art.

According to various embodiments, the service data database 416 may be configured to receive, store, and maintain service data 406 that may comprise any of a variety of information associated with one or more shipment requests submitted by one or more users of the system 20 described herein. As a non-limiting example, the service data 406 may comprise shipment routes, shipment service levels (e.g., standard, expedited, first class, priority, next day air, two day air, ground, media, and the like), shipment upgrade options (e.g., next flight out, next truck out, etc.), shipment delivery options (e.g., leave on site, signature required, redelivery attempts, redirection, real-time adjustments, and the like). It should be generally understood that the service data 406 in this manner may comprise any available options and/or services that a shipping provider may currently offer to its customers, noting of course that the exact contour of available services may differ between each of a plurality of addresses. As a non-limiting example, substantially rural and/or remote locations may not have “next day air” capability, whereas particular urban and/or crime-prone areas may not have “leave on site” capability. Still further, in any of these and still other embodiments, upon receipt, the service data database 416 will store any such received service data 406 in a manner associated with at least the data module 400 and for provision to at least the analysis module 600 (see FIG. 5), as will also be described in further detail below. Of course, in any of these and still other embodiments, a variety of alternative configurations could exist, as commonly known and understood in the art.

According to various embodiments, the reputation data database 417 may be configured to receive, store, and maintain reputation data 407 that may comprise any of a variety of information associated with one or more addresses within a shipping network incorporated within the system 20 described herein. With reference to FIG. 5, it should be understood that the reputation data 407 will according to various embodiments generally comprise at least score data 515, which may include a reputation score, for each address (e.g., location at which service is provided, or “service point” as such may sometimes be referred to), as may be (or have been—e.g., historically) determined by the calculation module 500 or otherwise. The reputation data 407 may also, in certain embodiments, include a variety of data, which may include a set of rules, scales, and parameter weightings, that may be applied via one or more algorithms and/or business rule engines (e.g., in conjunction with the scoring tool 510 as described later herein) so as to calculate a reputation score for each of a plurality of addresses within a carrier network.

In this regard, it should be understood that any of a variety of rankings, score baselines, and/or weights for parameters associated therewith may be incorporated within the reputation data 407, as may be desirable for particular applications. As a non-limiting example, the reputation score framework may be based upon a scale of 0-100, with a score of 100 being highest risk. In other embodiments, a score of zero may be highest risk. In still other embodiments, the scale may be that of 0-10, or any of a variety of other scales, as commonly known and understood in the art. One or more subcategories of rankings may also be associated with the scale and stored as reputation data 407. For example, 0-25 may be “highest risk” while 26-50 may be “medium risk” and 51-75 may be “low risk” with 76-100 representing “substantially no risk.” Such subcategories may be color-coded or otherwise distinguished from one another, as may be desirable for particular applications. In any event, it should generally be understood that regardless of the precise scale and subcategories therefor and the like selected and implemented, such will be applied by various embodiments of the system 20 described herein across all addresses incorporated within the system. In this manner, a consistent and relevant ranking system is provided across a plurality of addresses. Of course, in any of these and still other embodiments, upon receipt, the reputation data database 417 will store any such received reputation data 407 in a manner associated with at least the data module 400 and for provision to at least the calculation module 500 (see FIG. 5), as will also be described in further detail below. Of course, in any of these and still other embodiments, a variety of alternative configurations could exist, as commonly known and understood in the art.

According to various embodiments, any of the previously described databases may be configured to store and maintain not only textually based data, but also graphically based data, as may be generated by the system 20 (or otherwise) and be based, at least in part, upon the textually based data. Still further graphical (e.g., charts, graphs, maps, etc.) may also be stored within one or more of the databases, wherein such may be, at least in part, independently derived, relative to the textually based data. Non-limiting examples of such graphically based data include trend graphs, historical plot charts, pie charts, diagrams, and the like. It should further be understood that in any of these and still other embodiments, the graphically based data may be used to visually combine various portions of data contained within the various databases previously described herein. Still further, various algorithms and/or pre-determined parameters, rules, and/or mitigating procedures may also be stored within the system 20, as may be desirable for various applications for purposes of performing the various calculations, scorings, comparisons, and/or adjustments, as described elsewhere herein.

Summary of Exemplary System Operation

As indicated above, various embodiments of the address reputation server 200 execute various modules (e.g., modules 400, 500, 600, 700) to provide a tool that dynamically provides an address reputation service configured to facilitate shipment handling that accurately and efficiently accounts for one or more risk parameters associated with each of a plurality of addresses within a broader transportation network.

According to the embodiment shown in FIG. 5, the address reputation server 200 begins with the execution of the data module 400, which is configured to receive, store, manage, and transmit address data 410, which may comprise any of a variety of data associated with each of a plurality of service (e.g., delivery) points within a carrier's shipping and/or transportation network. In certain embodiments, at least a portion of the address data 410 is provided to the calculation module 500 for further processing, either automatically upon, for example, receipt of carrier data 401 or otherwise, as may be desirable for particular applications. In at least the illustrated embodiment of FIG. 5, at least a portion of the address data 410 may be likewise provided to the analysis module 600, which may, for example, use such for comparing the same against other portions of the address data. For example, order data 404 requesting delivery to a particular address may be assessed against shipper data 405 defining what conditions shipment to that point may be possible. Comparison and/or adjustments may also be performed against at least service data 406 and/or shipper data 405, so as to facilitate ultimate transport of the package or item, whether via mitigating steps or otherwise. Of course, it should be understood that various alternative configurations other than that illustrated in FIG. 5 may exist within the configured processes of the data module 400, all as will be described in further detail below.

In various embodiments, the calculation module 500 is configured to activate a scoring tool 510, which is configured to calculate a reputation score for the one or more addresses associated with the received address data 410. The reputation score may be accompanied by a variety of score data 515 in certain embodiments, as may be desirable for particular applications. In certain embodiments, the score data 515 may be influenced at least in part by a portion of the reputation data 407, for example to normalize the same to a uniform scale applied across all addresses within the system 20 described herein. In any event, upon generation of the score data 515, such is transmitted according to various embodiments to one or more of the analysis module 600 and/or the data module 400 for further processing. Such transmittal may be proactive or in response to a request or inquiry originating from one of the modules.

Remaining with FIG. 5, according to various embodiments, the analysis module 600 is configured to activate a comparison tool 610 upon receipt of at least certain portions of the address data 410. The comparison tool 610 is configured in certain embodiments to assess discrepancies and/or conflicts between subsets of the received portions of the data 410. Any identified discrepancies and/or conflicts are compiled as comparison data 615, which the analysis module 600 is configured, according to various embodiments, to provide as input to an adjustment tool 620. If no discrepancies and/or conflicts are identified, the comparison data 615, as may be generated, may be provided alternatively to the report module 700. The adjustment tool 620 in certain embodiments is configured to mitigate and/or otherwise address any areas of concern identified within the comparison data 615, thus generating adjustment data 625 that may, to some degree, modify the initially received address data 410. According to various embodiments, the comparison data 615 and/or the adjustment data 625 may be transmitted by the analysis module 600 to the report module 700.

According to various embodiments, the report module 700 is configured to activate a notification tool 710 to further process received score data 515, comparison data 615, and/or adjustment data 625. In certain embodiments, the report module 700 generates one or more reports 712, alerts 714, and/or instructions 716 to one or more users of the system (e.g., carrier, customer, etc.), however as may be desirable. All of these features and still further details surrounding the operation and configuration of the various modules 400, 500, and 600 will be described in further detail later herein.

Of course, various alternative configurations to that described above and generally illustrated in FIG. 5 may exist without departing from the nature and scope of the various embodiments of the present invention, all as will be described in further detail below.

Data Module 400

According to various embodiments, as previously mentioned herein, the data module 400 is configured to receive, store, manage, and transmit address data 410, which may comprise any of a variety of data associated with each of a plurality of service (e.g., delivery) points within a carrier's shipping network. Receipt may be from any of a variety of entities (e.g., a common carrier shipment provider, users of the system 20, and the like) depending upon the type and nature of the data (see also FIG. 4), and transmission thereof may be to one or more of the calculation and/or analysis modules 500-600, as will be described in further detail below.

FIG. 6 illustrates steps that may be executed by the data module 400 according to various embodiments. Beginning with step 450, the data module 400 assesses whether any data (e.g., address data 410, as illustrated in FIG. 5) has been received by the module. In certain embodiments, the data module 400 makes this assessment by periodically scanning one or more databases (see FIG. 4) associated with the module and by identifying some portion of data within one or more of the databases that was not present during a previous periodic scan under step 450. Of course, alternative configurations may be envisioned, wherein, as a non-limiting example, the data module 400 may actively receive data (e.g., as input by a user of the system 20 via an interface) and upon receipt thereof, execute step 450. In any of these and still other various embodiments, if “newly received” data is identified, the data module 400 proceeds to step 470; otherwise the module proceeds into a static loop via step 455.

During step 455, the data module 400 may be configured to passively stand by for receipt of new data, which may be in the form of any of the various types of address data 410 illustrated in FIGS. 4 and 5 and previously described herein. In certain embodiments, the module 400 may, in step 455, periodically (e.g., every 5 seconds, or at any desirable interval) proactively ping one or more databases contained therein. Of course, various alternative data monitoring configurations may be envisioned, without departing the scope and nature of the present invention.

Remaining with FIG. 6, upon receipt of at least some portion of address data 410, the data module 400 proceeds to step 470, during which the data module transmits the received data to at least one of the calculation module 500 and/or the analysis module 600 for further handling and processing. In certain embodiments, the address data 410 may be simultaneously or later transmitted additionally and/or alternatively to at least the analysis module 600. In other embodiments, it should be understood that the module to which data is transmitted depends at least in part upon the type of data received and context in which such receipt occurs. In any of these and still other embodiments, the data module 400 may be configured to automatically perform step 470, while in other embodiments, the module may perform such only periodically, at an interval predetermined by one or more users of the system 20, as may be desirable for particular applications. In still other embodiments, the data module 400 may automatically transmit a portion of the data (e.g., carrier data 401), while another portion of the data (e.g., public data 402 and/or forum data 403) may be transmitted subsequently, for example, upon request therefor by the calculation module 500, as will be described in further detail below. Of course, still further alternative configurations and/or process flows for execution by the data module 400 may be envisioned, without departing from the nature and scope of the various embodiments of the present invention.

A few non-limiting illustrations prove instructive with respect to execution of the data module 400. As a first non-limiting example, the data received (and identified) in step 450 may be near real-time tracking data transmitted to the data module 400 via one or more distributed handheld devices used by personnel of a common carrier (e.g., shipper of packages within the network associated with the system 20). Such data would be cataloged by the data module 400 according to certain embodiments as carrier data 401. As illustrated in FIG. 5, such carrier data 401 would be identified during step 450 and subsequently transmitted to the calculation module 500 during step 470.

As a second non-limiting example, the data received (and identified) in step 450 may be a shipment request from a user (e.g., customer) of the system, seeking transit and delivery of a package or item via one or more shipping carriers associated with the system. Such may occur, for example, during a purchase transaction that the customer has entered into with a retailer for purchase of the item being shipped. Upon receipt of such a request, at least a portion of the data contained therein would be cataloged as order data 404 (see FIG. 5), which would be not only stored within one or more databases (see FIG. 4) of the data module 400, but also transmitted according to step 470 to at least the analysis module 600, whereby it would be compared against at least some portion of shipper/carrier data 405 so as to ensure that any of a variety of parameters contained within the request (e.g., shipment via next day air transit) may be satisfied for the particular address to which delivery (or any of a variety of services, such as pickup, transfer, or otherwise) is requested.

Additional details with regard to each of these and still other non-limiting examples will be described in further detail elsewhere herein, particularly in the context of the execution of various steps via the calculation module 500 and the analysis module 600, as illustrated in at least FIGS. 7 and 8.

Calculation Module 500

As previously described, the calculation module 500 is configured to, upon receipt of any portion of address data 410, activate a scoring tool 510, which is configured to calculate a reputation score for the one or more addresses associated with the received address data 410.

With reference now to FIG. 7, which illustrates various steps that may be executed by the calculation module 500, according to various embodiments the module is configured to begin in step 530 by receiving at least some portion of address data 410 from the data module 400. It should be understood that in certain embodiments, the calculation module 500 may be configured to periodically and/or continuously proactively retrieve and/or check for new address data 410, as may be transmitted from the data module 400. In other embodiments, the calculation module 500 may merely passively await receipt of data from the data module 400, as may be desirable for particular applications.

According to various embodiments, data received in step 530 may comprise at least one of carrier data 401, public data 402, or forum data 404. With reference to the carrier data 401, such may be received in a near-real time fashion from a common carrier integrated with the system 20 described herein, such that tracking, transit, fraud, and various other type data, which may be associated with each of a plurality of addresses within the system. The public data 402 may be received via, as a non-limiting example, one or more network interfaces with law enforcement agencies and the like, so as to collect and/or access pertinent public data, as such has been described elsewhere herein. The forum data 404 may be received in a similar fashion, via one or more network interfaces, but with one or more forums in which users of the system (and in some instances external third parties) may contribute comments and/or feedback regarding addresses within the system. Of course, still other mechanisms and/or configurations for receiving such data and the particular locations wherefrom such are received and/or retrieved (as may be the case), may be envisioned, without departing from the scope and nature of various embodiments of the present invention.

Returning now with focus upon FIG. 7, if no data is identified as being received during step 530, the calculation module 500 is configured according to various embodiments to proceed to step 535, wherein the module may be configured to passively stand by for receipt of new data, which may be in the form of any of the various types of address data 410 as illustrated in FIGS. 4 and 5 and previously described herein. In certain embodiments, the calculation module 600 may, in step 535, periodically (e.g., every 5 seconds, or at any desirable interval) proactively ping one or more databases associated with the data module 400, so as to in a near-real-time fashion sync and thus identify received data efficiently and effectively. Of course, various alternative data monitoring configurations may be envisioned, without departing the scope and nature of the present invention.

Remaining with FIG. 7, upon receipt of at least some portion of address data 410, the calculation module 500 proceeds to step 540, wherein the module is configured to execute a scoring tool 510, which is configured generally to determine a reputation score for each of a plurality of addresses associated with the system 20. As an initial matter, execution of the scoring tool 510 may in certain embodiments involve further retrieval (see step 545) by the tool of additional components of one or more of carrier data 401, public data 402, and/or forum data 403. Such is necessary in these and other embodiments, where, as a non-limiting example, only new carrier data 401 is received during step 530, but for the scoring tool 510 to accurately determine a reputation score for a particular address, additional and/or complementary data points are necessary. In certain embodiments, the scoring tool 510 executes one or more algorithms and/or business rules, which are configured to apply a set of business rules and/or to assess a variety of predetermined parameters (and/or weighting thereof) so as to output a single reputation score that is appropriately adapted to a further predetermined scale (e.g., 0-100, where the lower the score, the higher the risk associated with the address). In these and still other embodiments, the reputation score is incorporated within score data 515, as such is generated during step 550, via execution of the scoring tool 510 during step 540.

A few non-limiting examples prove insightful. Consider the receipt of forum data 403, whereby user A has posted a comment (e.g., on a forum website and/or interface, whether directly associated with the system 20 or otherwise) indicating that he had delivery issues with address B. According to certain embodiments, upon receipt of that posted comment by the data module 400 (as described previously herein), such would be categorized, stored, and maintained as forum data 403 and transmitted to the calculation module 500. The module would in turn execute scoring tool 510 so as to either calculate an initial reputation score for the address B (e.g., if address B was not previously scored by the system 20) or to calculate a revised/updated reputation score, at least in part in view of the content of the posted comment. In this process, additional carrier data 401 and/or public data 402, and/or still other portions of the address data 410 generally may also be queried and/or retrieved so as to, in a sense “paint a complete picture” of the “reputation” of address B, for purposes of scoring the same.

Continuing with the forum data 403 non-limiting example, in various embodiments, certain types of data received within the scoring tool 510 may be weighted (e.g., via various business rules associated with the tool and/or one or more algorithms executed thereby) so as to have a lesser impact upon the reputation score, for example where the posted comment is simply by a third party, perhaps posting that they've “heard of issues with address B” as opposed to transmitting first-hand knowledge. Any of a variety of weights, classifications, and the like may be envisioned, as are commonly known and understood in the art. However, it should be understood that the execution of the scoring tool 510 will result in a singular output reputation score within the score data 515 for, in this scenario, address B. Such score may be further adapted to a uniform scale applied across all addresses (e.g., a comparative scale between 0-100, wherein lower scores are indicative of higher risk and the like). Alternative scales may be envisioned, provided such create a uniform framework across the system 20.

As another non-limiting example, the data received by the calculation module 500 in step 530 may be a criminal conviction record newly posted for a resident of address C, which data may be classified, upon receipt into the system 20 as public data 402, as such has been previously described herein. The scoring tool 510 will, in certain embodiments, similarly to as described above execute one or more algorithms based upon this and still other data, perhaps applying a greater weight to such criminal conviction data, as compared to the weight given to the forum post described above. In this manner, it may be seen that the output score data 515 may be 15 out of 100, thus representing a high risk address C, due at least in part to its resident being convicted of a crime. In other non-limiting examples, not detailed herein, it may be further understood that the nature of the crime and differences of degree between various crimes may also be weighted relative to one another, so as to impose varying degrees of impact upon the reputation score, as may be predefined and pre-established by one or more users of the system.

In still another non-limiting example, a combination of carrier tracking data (e.g., carrier data 401) and order data 404 may be received, wherein due to various factors the delivery point for package A must be changed from address D to address E. This may be due to environmental issues encountered with the package, that may require expedited delivery, or simply due to changing demands of a customer/recipient of the package. Any of a variety of influencing factors may be envisioned, as such are commonly encountered in the transportation of packages. In any event, upon receipt of such data, the calculation module 500 may be triggered to execute the scoring tool 510 so as to determine a reputation score for the new address E, if such does not already exist. If such exists, the calculation module 500 may simply provide such score data 515 to the analysis module 600 for further processing, as will be described further below.

Returning now to FIG. 7, upon generation of score data 515, necessarily including at least the reputation score for one or more addresses, the calculation module 500 is configured according to various embodiments to proceed from step 550 and to step 555, wherein a handful of things may occur. In certain embodiments, the score data 515 may be transmitted to the data module 400, wherein such may be incorporated within, for example, existing reputation data 407 (see FIG. 5) and associated with the appropriate address therefor.

In other embodiments, the score data 515 may be transmitted to the report module 700, and in particular to the notification tool 710 thereof, via which such may be further transmitted to one or more users of the system via one or more reports 712 and/or alerts 714, as will be described in further detail elsewhere herein. It should be understood that in such and other embodiments, the one or more notified users may, in turn, provide some sort of response (e.g., data) back into the system 20, which may in turn be processed by the data module 400, the calculation module 500, and/or the analysis module 600, as described elsewhere herein, thus creating a sort of iterative data exchange process.

In still other embodiments, the score data 515 may be transmitted to the analysis module 600 and in particular to the comparison tool 610 thereof. Such may occur, for example, where additional data (e.g., order data 404) has also been received by the data module 400, such that the score data 515 is required to, at least in part, compare one or more parameters within the order data 404 with one or more parameters within, for example, shipper data 405 also stored within the data module. Of course, in any of these described and other embodiments, during step 555, the calculation module 500 may be configured to transmit any portion of the score data 515 to any combination of the various modules 400, 600, 700 described herein and/or any tools associated therewith, as may be desirable in certain applications. In certain embodiments, the transmissions may further be substantially simultaneous to the one or more modules, whereas in other embodiments, the transmissions of step 555 may be sequential and/or even temporally separated relative to one another, whereby between successive partial transmissions, one or more of the remaining module 400, 600, and/or 700 may execute one or more intermediary steps, as described elsewhere herein.

Analysis Module 600

As previously described, the analysis module 600 is configured to, upon receipt of any portion of address data 410, at least initially execute a comparison tool 610, which is configured assess discrepancies and/or conflicts between subsets of the received portions of the data 410 and generate such as comparison data 615. The comparison data 615 may then, upon receipt of further data in at least one embodiment, then operates as an input to an adjustment tool 620, which is configured to mitigate and/or otherwise address any areas of concern identified within the comparison data 615, thus generating adjustment data 625 that may, to some degree, modify the initially received address data 410.

With reference now to FIG. 8, which illustrates various steps that may be executed by the analysis module 600, according to various embodiments the module is configured to begin in step 630 by receiving at least some portion of address data 410 from the data module 400 and/or some portion of score data 515 from the calculation module 500. It should be understood that in certain embodiments, the analysis module 600 may be configured to periodically and/or continuously proactively retrieve and/or check for at least the address data 410, as may be transmitted from the data module 400. In other embodiments, the analysis module 600 may merely passively await receipt of data from the data module 400, as may be desirable for particular applications. In any of these and still other embodiments, the analysis module 600 will generally passively await receipt of score data 515 from the calculation module 500 and in certain embodiments, the module 600 will only retrieve such (albeit then proactively) upon receipt of some portion of address data 410, as will be described in the non-limiting examples further below.

According to various embodiments, data received in step 630 from the data module 400 may comprise at least one of order data 404, shipper data 405, and/or service data 406. With reference to the order data 404, such may be received in a near-real time fashion from a user (e.g., customer or retailer or the like) interface that is in some form or fashion integrated with the system 20 described herein. The order data 404 may comprise a customer request to have a package shipped from a retail location to a particular address. The shipper data 405 may be received via, as a non-limiting example, one or more network interfaces with one or more shipping service providers associated with the system 20. For example, the shipper data 405 may comprise one or more parameters, by which the shipper applies a rate structure across multiple shipment points, which parameters may change and/or be adjusted over time. The service data 406 may similarly be received via, as a non-limiting example, one or more network interfaces with the one or more shipping service providers, but instead of rating parameters, such data may further comprise data related to available service levels, for example, which services (e.g., next day air, ground, etc.) are or are not available for particular addresses. Of course, still other mechanisms and/or configurations for receiving such data and the particular locations wherefrom such are received and/or retrieved (as may be the case), may be envisioned, without departing from the scope and nature of various embodiments of the present invention.

Returning now with focus upon FIG. 8, if no data is identified as being received during step 630, the analysis module 600 is configured according to various embodiments to proceed to step 635, wherein the module may be configured to passively stand by for receipt of new data, which may be in the form of any of the various types of address data 410 as illustrated in FIGS. 4 and 5 and previously described herein. In certain embodiments, the analysis module 600 may, in step 635, periodically (e.g., every 5 seconds, or at any desirable interval) proactively ping one or more databases associated with the data module 400, so as to in a near-real-time fashion sync and thus identify received data efficiently and effectively. Of course, various alternative data monitoring configurations may be envisioned, without departing the scope and nature of the present invention.

Remaining with FIG. 8, upon receipt of at least some portion of address data 410, the analysis module 600 proceeds to step 640, wherein the module is configured to execute a comparison tool 610, which is configured generally to determine whether any discrepancies and/or conflicts between subsets of the received portions of the data 410. For example, where order data 404 is received wherein a customer requests next day air shipment by shipper A between city B and address C, and where service data 406 (whether received or otherwise retrieved by the comparison tool 610—see step 645) indicates that only two day air service is available between B and C, the comparison tool 610 would identify such as a conflict and/or discrepancy and annotate such within, for example, any comparison data 615, as generated via step 650.

As another non-limiting example, where order data 404 is received under the same circumstances (e.g., next day air by shipper A between city B and address C) but further requesting a price point of X, the comparison tool 610 may be further configured according to various embodiments to further request and/or retrieve score data 515 for address C, which may, together with shipper data 405 indicate that the request may only be satisfied by shipper A at a price point of X+$10. Such may be due, at least in part to a surcharge that may be applied to the request based at least in part upon the reputation score for the address C and/or one or more parameters within the shipper data 405, however as may have been pre-established by the shipment transit provider.

In various embodiments, as described previously herein in the context of the scoring tool 510, the comparison tool 610 is configured to execute one or more algorithms and/or business rules, which are designed to apply a set of business rules and/or to assess a variety of predetermined parameters (and/or weighting thereof) so as to output an indication of whether one or more discrepancies, issues, conflicts, or the like exist between one or more parameters being compared by the tool. It should be understood, however, that during step 650, comparison data 615 may nevertheless be generated according to certain embodiments, even when no such discrepancies, issues, conflicts, or the like are identified, wherein such may be nevertheless transmitted to at least the report module 700 for further processing as described elsewhere herein.

Where one or more discrepancies, issues, conflicts, or the like are identified and cataloged accordingly within the comparison data 615 generated during step 650, the analysis module 600 is configured according to various embodiments to either similarly transmit the same to at least the report module 700 for further processing during step 655 (as above) or transmit the same to the adjustment tool 620 during step 660, as will be described further below. As a non-limiting example, in certain embodiments, one or more users of the system (e.g., customers and/or shippers) may want to be notified immediately of any identified discrepancies, issues, conflicts, or the like, prior to execution of the adjustment tool 620. For example, even though a request may be to ship to a particular address with a relatively high risk reputation score that would generally require imposition of a surcharge (e.g., per a shipper's pre-established parameters), the shipper may want to be notified of such. In at least one embodiment, the shipper may decide, as a non-limiting example to either reduce and/or waive the surcharge, where for example the address is in a geographic area in which the shipper is looking to expand business and grow volume. Of course, any of a variety of scenarios may be envisioned and the analysis module 600 is thus configured to accommodate such, whereby the report module 700 may be called to generate and transmit one or more notifications to one or more users of the system, upon generation of the comparison data 615 during step 650.

With continued reference to FIG. 8, upon generation of comparison data 615 that indeed contains one or more discrepancy, issue, conflict, or the like, the analysis module 600 is configured to proceed to step 670, whereby an adjustment tool 620 is executed to at least in part adjust one or more parameters of either the received and/or retrieved address data 410 so as to, to some degree, mitigate the discrepancy, issue, conflict, or the like. In at least one embodiment, continuing with the non-limiting example from above, the analysis module 600 may receive data from the shipper to reduce a required surcharge for a particular address in a particular instance, whereby the execution of the adjustment tool 620, via activation of one or more algorithms and/or business rule engines (as previously described herein) will generate adjustment data 625 during step 680, which data 625 will be indicative of the mitigating instructions from, for example, the shipper.

As may be seen from FIG. 8, service data 406 and/or shipper data 405 and/or any portion of address data 410 may be further retrieved by the adjustment tool 620 during the execution thereof, so as to perform a complete and accurate assessment of the data input, so as to generate correspondingly accurate and complete adjustment data 625. In certain embodiments, although it has been described previously as the adjustment tool 620 receive some portion of data from one or more users of the system instructing one or more actions to take upon execution of the adjustment tool, the adjustment tool 620 may also be executed in a substantially automated fashion following generation of the comparison data 615 during step 650, whether users of the system are concurrently notified via data transmission in step 655 or not.

For example, wherein the comparison data 615 indicates that next day air is not available due to the location of the address and that shipping at rate X is not available due to the reputation score of the address, the analysis module 600 may be configured according to various embodiments to automatically transmit such data to the adjustment tool (step 660) and execute the adjustment tool 620. In so doing, the adjustment tool 620 may further retrieve, as a non-limiting example, service data 406, which may be indicative of alternative services available for the particular address in question, whereby the generated adjustment data 625 may indicate that two day air shipment is available to address C and/or that next day air is available, but only to address B, which may be two miles away from address C. In certain embodiments, the adjustment tool 620 may be further configured to automatically choose between a plurality of identified “possible” adjustments and to further finalize any such adjustments within the adjustment data 625, prior to transmittal of the same to at least the report module 700 in step 685. In other embodiments, one or more “possible” adjustments may be transmitted to the report module 700 during step 685, after which one or more users of the system, upon being notified of the same, may further invoke the analysis module 600 to finalize and such.

Indeed, any of a variety of alternative process flows, other than that specifically illustrated in FIG. 8 may be implemented, provided such satisfy one or more parameters as may be pre-established by one or more users of the system and in doing so facilitates transport of one or more packages in accordance with one or more requests therefor after taking into consideration a reputation score for the address to which delivery is requested.

Of course, in any of these described and other embodiments, during steps 655 and 685, the analysis module 600 may be configured to transmit any portion of the data (615, 625) to any combination of the various modules 400, 600, 700 described herein and/or any tools associated therewith, as may be desirable in certain applications. In certain embodiments, the transmissions may further be substantially simultaneous to the one or more modules, whereas in other embodiments, the transmissions of step 555 may be sequential and/or even temporally separated relative to one another, whereby between successive partial transmissions, one or more of the remaining module 400, 600, and/or 700 may execute one or more intermediary steps, as described elsewhere herein.

Report Module 700

With reference to FIG. 9, according to various embodiments, the report module 700 is configured to generally receive various types of data from one or more of the data module 400, the calculation module 500, and/or the analysis module 600, and to subsequently perform further processing steps based thereon. Beginning with step 730, the report module 700 may be configured to query whether any items of data (e.g., score data 515, comparison data 615, adjustment data 625, reputation data 407, and/or any portion of the address data 410 (as may be desirable for transmission according to certain embodiments) have been received by the report module. If no data has been received, the report module 700 is configured according to various embodiments to proceed to step 735, wherein the module stands by to receive one or more pieces of data. In certain embodiments, the report module 700 may simply passively await receipt of data during step 735, while in other embodiments, the report module 700 may at least periodically (e.g., as pre-determined by one or more users of the system 20) actively query one or more of the modules 400-600 for data, as may be desirable for particular applications. Of course, any of a variety of data calling and/or transmission configurations may be envisioned, without departing from the scope and nature of the present invention.

Remaining with FIG. 9, upon receipt of data in step 730, various embodiments of the report module 700 are configured to proceed to step 740, during which a notification tool 710 is executed to perform the remaining steps 745-775, as illustrated. With reference to step 745, execution of the notification tool 710 involves according to various embodiments first determining what specific type of data has been received. If at least a portion of the received data includes score data 515, the report module 700 is configured to proceed to step 750, wherein such is identified accordingly.

Following such identification of at least some portion of score data 515 during step 750, the notification tool 710 is further configured, via step 755 to generate one or more reports 712 and/or alerts 714 based thereon. The determination of whether reports and/or alerts are necessary may be informed, at least in part based upon one or more notification parameters, as may be pre-established by one or more users (e.g., shippers, carriers, customers, etc.) of the system 20, however as may be desirable according to various embodiments. Non-limiting examples of reports 712 may comprise an email message, a document detailing status and/or actions taken by the system, and/or any of a variety of textual and/or graphical depictions thereof, as are commonly known and understood in the art. Non-limiting examples of alerts 714 may be more simplistic notifications, requiring a recipient thereof to access a separate application to obtain detailed information, as is also commonly known and understood in the art.

Upon generation of one or more reports 712 and/or alerts 714 during step 755 the report module 700 according to various embodiments is configured to proceed to step 785, wherein the one or more reports and/or alerts are transmitted to one or more users (e.g., shippers, carriers, customers, etc.) of the system. In certain embodiments, the generated reports 712 and/or alerts 714 may be further transmitted to at least the data module 400, wherein such may be stored, maintained, and/or cataloged within the address data 410 for future reference, where such may be beneficial for certain applications.

Remaining with the first ongoing non-limiting example described previously herein, where carrier data 401 (or alternatively public data 402 and/or forum data 403) has been processed by the system 20, a notification of the updated (e.g., impacted thereby) score data 515, which may necessarily include a revised reputation score for the particular address in question, may be transmitted to at least a user residing at that address. Additional and/or alternative notifications may also be issued to shipper and/or carrier providers, in certain embodiments.

Returning to step 745 as illustrated in FIG. 9, if such additionally and/or alternative identifies at least some portion of comparison data 615 such is identified accordingly during step 760. The notification tool 710 is further configured, via step 765 to generate one or more reports 712 and/or alerts 714 based thereon. The determination of whether reports and/or alerts are necessary may be informed, at least in part based upon one or more notification parameters, as may be pre-established by one or more users (e.g., shippers, carriers, customers, etc.) of the system 20, however as may be desirable according to various embodiments. Non-limiting examples of reports 712 may comprise an email message, a document detailing status and/or actions taken by the system, and/or any of a variety of textual and/or graphical depictions thereof, as are commonly known and understood in the art. Non-limiting examples of alerts 714 may be more simplistic notifications, requiring a recipient thereof to access a separate application to obtain detailed information, as is also commonly known and understood in the art.

Upon generation of one or more reports 712 and/or alerts 714 during step 765 the report module 700 according to various embodiments is configured to proceed to step 785, wherein the one or more reports and/or alerts are transmitted to one or more users (e.g., shippers, carriers, customers, etc.) of the system. In certain embodiments, the generated reports 712 and/or alerts 714 may be further transmitted to at least the data module 400, wherein such may be stored, maintained, and/or cataloged within the address data 410 for future reference, where such may be beneficial for certain applications.

With reference to the second ongoing non-limiting example referred to previously herein, where via operation of the analysis module one or more discrepancies are identified between a shipment request (e.g., order data 404) and shipper data 405, for example such that the shipper's pre-established rules require imposition of a 10% surcharge due to a particular address's less than stellar reputation score, the report module 700 may be configured to generate and transmit at least one of a report 712 and/or alert 714 thereof to at least one of the customer and the shipper. In certain circumstances the shipper may decide to waive the 10% surcharge, which information would then be returned to at least the data module 400 according to various embodiments, as described elsewhere herein. In other embodiments, the customer may opt to select an alternative shipper and/or forego the cost of purchasing and shipping the particular item in question. In still other embodiments, such data may be returned to at least the analysis module 600 for assessment via at least the adjustment tool 620, as described previously herein.

Returning again to step 745 as illustrated in FIG. 9, if such additionally and/or alternative identifies at least some portion of adjustment data 625 such is identified accordingly during step 770. The notification tool 710 is further configured, via step 775 to generate one or more reports 712 and/or alerts 714 and/or instructions 716 based thereon. The determination of whether reports and/or alerts and/or instructions are necessary may be informed, at least in part based upon one or more notification parameters, as may be pre-established by one or more users (e.g., shippers, carriers, customers, etc.) of the system 20, however as may be desirable according to various embodiments. Non-limiting examples of reports 712 may comprise an email message, a document detailing status and/or actions taken by the system, and/or any of a variety of textual and/or graphical depictions thereof, as are commonly known and understood in the art. Non-limiting examples of alerts 714 may be more simplistic notifications, requiring a recipient thereof to access a separate application to obtain detailed information, as is also commonly known and understood in the art.

Non-limiting examples of instructions 716 may be textual and/or computer program-based code configured to facilitate implementation of one or more actions necessary to begin the shipment/transit process for the package being sent to one of the plurality of addresses within the network. For example, the instructions may instruct a shipper's labeling department (or software program) to apply a surcharge rate indication upon a label applied to the package prior to shipment. As another non-limiting example, the instructions may instruct a retailer to apply the surcharge rate to any final accounting, for example prior to finalizing and completing any ongoing checkout procedures (e.g., via an electronic interface or website) with the customer requesting shipment. Any of a variety of options and configurations of instructions may be envisioned, provided such facilitate efficient and accurate shipment and payment processing for the packages being subsequently placed into transit.

As alluded to above, upon generation of one or more reports 712 and/or alerts 714 and/or instructions 716 during step 775 the report module 700 according to various embodiments is configured to proceed to step 785, wherein the one or more reports and/or alerts are transmitted to one or more users (e.g., shippers, carriers, customers, etc.) of the system. In certain embodiments, the generated reports 712 and/or alerts 714 and/or instructions 716 may be further transmitted to at least the data module 400, wherein such may be stored, maintained, and/or cataloged within the address data 410 for future reference, where such may be beneficial for certain applications.

With reference to the second ongoing non-limiting example referred to previously herein, where via operation of the analysis module one or more discrepancies are identified between a shipment request (e.g., order data 404) and shipper data 405, for example such that the shipper's pre-established rules require imposition of a 10% surcharge due to a particular address's less than stellar reputation score, the analysis module 600, as has been described previously herein, may have further applied the surcharge via execution of the adjustment tool 625, thus resulting in the generation of the adjustment data 625. Under such circumstances, the report module 700 may be configured to generate and transmit at least one of a report 712 and/or alert 714 and/or instructions 716 thereof to at least one of the customer and the shipper and/or the retailer. In certain circumstances the instructions may provide further direction so as to seamlessly, and in some cases substantially electronically and/or automatically, facilitate further transit and shipment of the package or item to the appropriately designated address within the network.

It should be noted further that although the above reporting activities, as performed by the report module 700, have been described in the context of preparing a package or shipment for transit (e.g., in advance of actual transit), such could also occur according to various embodiments during ongoing transit activities. For example, received carrier data 401 may indicate that for some reason (e.g., delay, spoilage, etc.) a package must be rerouted to a different address for pick-up by the customer, the analysis module 600 may be configured to execute one or more tools, as previously described herein so as to determine whether one or more additional adjustments are necessary, based upon the updated address data. Upon execution of the analysis module 600 under such circumstances, the report module 700 may be subsequently executed, as described immediately above and/or alternatively in another fashion, as may be desirable according to particular applications.

### CONCLUSION

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An address reputation system for dynamically handling shipments for each of a plurality of addresses based at least in part upon a reputation score calculated therefor, said system comprising:
one or more memory storage areas containing existing address data associated with at least one of said plurality of addresses; and
one or more computer processors configured to:
(A) receive new address data comprising order data associated with at least one shipment order for which delivery is requested to at least one of said plurality of addresses;
(B) retrieve at least a portion of said existing address data, said portion being associated with said address to which delivery is requested within said new address data;
(C) dynamically compare one or more portions of said new address data against one or more portions of said retrieved existing address data so as to identify one or more discrepancies there-between, said one or more discrepancies being indicative of at least one parameter within said new address data conflicting with a reputation score for said address to which delivery is requested;
(D) in response to identifying one or more discrepancies, prevent further processing of said at least one shipment order within said new address data; and
(E) in response to not identifying one or more discrepancies, facilitate further processing of said at least one shipment order within said new address data.

2. The address reputation system of claim 1, wherein:
prior to dynamically compare one or more portions of said new address data against one or more portions of said retrieved existing address data so as to identify one or more discrepancies there-between, said one or more computer processors are further configured to calculate said reputation score for said address to which delivery is requested, said calculation being based at least in part upon one or more parameters associated with said address; and
when dynamically comparing said one or more portions of said new address data against one or more portions of said retrieved existing address data so as to identify one or more discrepancies there-between, said one or more computer processors are further configured to compare said calculated reputation score against said one or more portions of said retrieved existing address data.

3. The address reputation system of claim 2, wherein said one or more portions of said retrieved existing address data comprise at least one of the following: carrier data associated with transport of one or more packages to said address, public data associated with one or more public records for one or more residents of said address, or forum data associated with one or more public forum interfaces via which information associated with said address may be received from a plurality of sources.

4. The address reputation system of claim 1, wherein:
said existing address data comprises one or more parameters associated with rate structures for one or more shippers, said rate structures being based at least in part upon a scale associated with said reputation score; and
said one or more discrepancies are identified based upon one or more differences between said rate structure parameters and said order data.

5. The address reputation system of claim 1, wherein:
said existing address data comprises one or more parameters associated with transit services available via one or more shippers, said transit services being based at least in part upon a geographical location of each of said plurality of addresses; and
said one or more discrepancies are identified based upon one or more differences between said transit service parameters and said order data.

6. The address reputation system of claim 1, wherein said one or more computer processors are configured to, in response to identifying one or more discrepancies, generate one or more notifications comprising data associated with said one or more discrepancies.

7. The address reputation system of claim 6, wherein said one or more notifications comprise at least one of the following: at least one report, at least one alert, or at least one computer code-based instructions.

8. The address reputation system of claim 6, wherein said one or more computer processors are configured to automatically transmit said one or more notifications to at least one user of said system.

9. The address reputation system of claim 8, wherein:
in response to receiving further input data from said at least one user of said system, said one or more computer processors are further configured to dynamically compare one or more portions of said further input data against said one or more portions of said retrieved existing address data so as to determine whether said one or more discrepancies continue to exist; and
in response to said one or more discrepancies being mitigated, facilitate further processing of said at least one shipment order within said new address data.

10. The address reputation service of claim 9, wherein:
said further input data comprises an indication of one or more errors in said reputation score; and
said one or more computer processors are further configured to re-calculate said reputation score for said address to which delivery is requested, said re-calculation being based at least in part upon one or more parameters associated with said address and said further input data.

11. The address reputation system of claim 1, wherein, in response to identifying one or more discrepancies, said one or more computer processors are further configured to determine one or more adjustments to one or more portions of said new address data so as to mitigate said one or more discrepancies.

12. The address reputation system of claim 11, wherein said one or more adjustments comprise at least one of the following: a rate adjustment based at least in part upon said reputation score, a service adjustment based at least in part upon said reputation score, or a waiver based at least in part upon at least one or more instructions provided by a shipper via which delivery is requested.

13. The address reputation system of claim 11, wherein said one or more computer processors are configured to, in response to identifying one or more adjustments, generate one or more notifications comprising data associated with said one or more adjustments.

14. The address reputation system of claim 13, wherein said one or more notifications comprise at least one of the following: at least one report, at least one alert, or at least one computer code-based instructions.

15. The address reputation system of claim 13, wherein said one or more computer processors are configured to automatically transmit said one or more notifications to at least one user of said system.

16. The address reputation system of claim 15, wherein:
in response to receiving further input data from said at least one user of said system, said one or more computer processors are further configured to dynamically compare one or more portions of said further input data against said one or more portions of said retrieved existing address data so as to determine whether said one or more discrepancies continue to exist; and
in response to said one or more discrepancies being mitigated, facilitate further processing of said at least one shipment order within said new address data.

17. The address reputation system of claim 11, wherein:
in response to receiving further input data from said at least one user of said system, said one or more computer processors are further configured to dynamically compare one or more portions of said further input data against said one or more portions of said retrieved existing address data so as to determine whether said one or more discrepancies continue to exist; and
in response to said one or more discrepancies being mitigated, facilitate further processing of said at least one shipment order within said new address data.

18. A computer-implemented method for dynamically handling shipments for each of a plurality of addresses based at least in part upon a reputation score calculated therefor, said method comprising the steps of:
(A) receiving and storing within one or more memory storage areas existing address data associated with at least one of said plurality of addresses;
(B) receiving new address data comprising order data associated with at least one shipment order for which delivery is requested to at least one of said plurality of addresses;
(C) dynamically comparing, via at least one computer processor, one or more portions of said new address data against one or more portions of said retrieved existing address data so as to identify one or more discrepancies there-between, said one or more discrepancies being indicative of at least one parameter within said new address data conflicting with a reputation score for said address to which delivery is requested;
(D) in response to identifying one or more discrepancies, preventing, via said at least one computer processor, further processing of said at least one shipment order within said new address data; and
(E) in response to not identifying one or more discrepancies, facilitating, via said at least one computer processors, further processing of said at least one shipment order within said new address data.

19. The computer-implemented method of claim 18, further comprising the steps of:
prior to dynamically comparing one or more portions of said new address data against one or more portions of said retrieved existing address data so as to identify one or more discrepancies there-between, calculating, via said at least one computer processor, said reputation score for said address to which delivery is requested, said calculation being based at least in part upon one or more parameters associated with said address; and
when dynamically comparing said one or more portions of said new address data against one or more portions of said retrieved existing address data so as to identify one or more discrepancies there-between, further comparing, via said at least one computer processor, said calculated reputation score against said one or more portions of said retrieved existing address data.

20. The computer-implemented method of claim 18, further comprising the step of in response to identifying one or more discrepancies, generating, via said at least one computer processor, one or more notifications comprising data associated with said one or more discrepancies.

21. The computer-implemented method of claim 18, further comprising the step of, in response to identifying one or more discrepancies, determining, via said at least one computer processor, one or more adjustments to one or more portions of said new address data so as to mitigate said one or more discrepancies.

22. The computer-implemented method of claim 21, further comprising the step of in response to identifying one or more adjustments, generating, via said at least one computer processor, one or more notifications comprising data associated with said one or more adjustments.

23. A non-transitory computer program product comprising at least one computer-readable storage medium having computer-readable program code portions embodied therein, the computer-readable program code portions comprising:
(A) a first executable portion configured for receiving a plurality of data, wherein said data comprises:
(i) existing address data associated with at least one of a plurality of addresses; and
(ii) new address data comprising order data associated with at least one shipment order for which delivery is requested to at least one of said plurality of addresses;
(B) a second executable portion configured for dynamically comparing one or more portions of said new address data against one or more portions of said retrieved existing address data so as to identify one or more discrepancies there-between, said one or more discrepancies being indicative of at least one parameter within said new address data conflicting with a reputation score for said address to which delivery is requested; and
(c) a third executable portion configured for:
(i) in response to identifying one or more discrepancies, prevent further processing of said at least one shipment order within said new address data; and
(ii) in response to not identifying one or more discrepancies, facilitate further processing of said at least one shipment order within said new address data.

24. An address reputation system for dynamically determining a reputation score for each of a plurality of addresses, said system comprising:
one or more memory storage areas containing existing address data, said existing address data comprising carrier data associated with transport of one or more packages to each of said plurality of addresses and third party data associated with each of said plurality of addresses; and
one or more computer processors configured to:
(A) receive new address data associated with at least one of said plurality of addresses;
(B) calculate a reputation score for said at least one address, said calculation being based at least in part upon one or more parameters within said carrier data and said third party data associated with said at least one address for which new address data was received; and
(C) upon completion of said calculation, generate one or more notifications, said one or more notifications comprising said reputation score for said at least one address.

25. The address reputation system of claim 24, wherein said carrier data and said third party data are configured to provide a comprehensive historical data set for shipment handling for each of said plurality of addresses.

26. The address reputation system of claim 24, wherein said carrier data comprises one or more of the following: address package tracking statistics, address delivery statistics, address shipping statistics, or address fraud statistics.

27. The address reputation system of claim 24, wherein:
said third party data comprises at least one of public data or forum data; and
said third party data is received by the system via an external service provider.

28. The address reputation system of claim 27, wherein:
said public data comprises at least one of the following: demographic data, fraud complaint data, civil legal complaint data, criminal legal complaint data, legal judgment data, or law enforcement record data; and
said one or more parameters upon which said reputation score is calculated is based at least in part upon one or more portions of said public data.

29. The address reputation system of claim 27, wherein said forum data comprises one or more user-generated pieces of information associated with at least one of said addresses, said user-generated pieces of information being associated with one or more parameters upon which said reputation score is calculated.

30. The address reputation system of claim 27, wherein said external service provider is configured such that a variety of users of said external service provider may generate at least a portion of said forum data, said reputation score being calculated based at least in part upon said portion of said forum data.

31. The address reputation system of claim 30, wherein at least one of said variety of users of said external service provider is a resident of at least one of said plurality of addresses and said at least one user generates at least a portion of said forum data associated with their particular address.
